(19) United States
(12) Patent Application Publication
(10) Pub. No.: US 2008/0243818 A1
(43) Pub. Date: Oct. 2, 2008

(54) CONTENT-BASED ACCOUNTING METHOD IMPLEMENTED IN IMAGE REPRODUCTION DEVICES

(75) Inventor: Wei Ming, Cupertino, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/694,827

(22) Filed: Mar. 30, 2007

(51) Int. Cl. G06F 17/30

(52) U.S. Cl. 707/5

(57) ABSTRACT

A content-based accounting method is implemented in a management section for a copier, scanner, printer or multifunction device (referred to as MFP), or on a networked server accessible by the copier, scanner, printer or MFP. When copying, scanning or printing a document, the management section automatically extracts content information from the documents being copied, scanned or printed, groups the documents based on the content, and updates an accounting database. The accounting database contains user accounts that store usage information according to content groups. For copied and scanned documents, textual content is extracted from the document image using OCR techniques. For printed documents, textual information is extracted from the digital data used to print the document.

### BACKGROUND OF THE INVENTION

This invention relates to a method and software for managing copiers, scanners, printers and/or multifunction devices, and in particular, it relates to an accounting method used in or with copiers, scanners, printers and/or multifunction devices.

### SUMMARY

Software programs have been used to analyze the content of documents for a variety of purposes, such as document indexing and document management. Optical character recognition (OCR) techniques are also widely used to extract textual information from images of documents. Embodiments of the present invention implement these techniques in copiers, scanners, printers or multifunction devices (sometimes referred to as MFPs or AIOs (all-in-one devices), which are devices that combine copy, scan and print functions) to perform content-based accounting and management functions, as well as other functions such as market research.

Conventionally, relatively simple accounting functions can be implemented on copiers, scanners, printers or MFPs, such as recording the number of pages printed, the number of copies made, etc. Copiers, scanners, printers or MFPs can also be equipped with access control devices that require users to provide certain information in order to access the device, such as user accounts, reference codes, etc., and can perform accounting using the user-provided information. Embodiments of the present invention improves the accounting function by allowing accounting to be performed based on content of the documents being copied, scanned or printed.

An object of the present invention is to provide a content-based accounting method for a copier, scanner, printer or MFP.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for managing an image reproduction device for copying or scanning a document, which includes: (a) copying or scanning the document using the image reproduction device, including obtaining a digital image of the document; (b) analyzing content of the digital image of the document; (c) grouping the document based on the analysis of the content; and (d) updating an accounting database based on the grouping of the document, the accounting database containing user accounts and storing usage information for each user account according to content groups.

In another aspect, the present invention provides a method for managing an image reproduction device for printing a document from digital data, which includes: (a) printing the document from the digital data using the image reproduction device; (b) analyzing content of the digital data; (c) grouping the document based on the analysis of the content; and (d) updating an accounting database based on the grouping of the document, the accounting database containing user accounts and storing usage information for each user account according to content groups.

In another aspect, the present invention provides an image reproduction device, which includes: a scanning section for generating digital images representing a document by scanning a physical medium; an accounting database containing user accounts and storing usage information for each user account according to document content groups; and a management section for analyzing content of digital images generated by the scanning section, grouping the document represented by the digital image or digital data based on the analysis of the content, and updating the accounting database based on the grouping of the document.

In another aspect, the present invention provides an image reproduction device, which includes: a printing section for forming images on a physical medium from digital data representing a document supplied to the printing section; an accounting database containing user accounts and storing usage information for each user account according to document content groups; and a management section for analyzing digital data supplied to the printing section, grouping the document represented by the digital data based on the analysis of the content, and updating the accounting database based on the grouping of the document.

In yet another aspect, the present invention provides a method for managing an image reproduction device for copying or scanning a document, which includes: (a) scanning the document using the image reproduction device to obtain a digital image of the document; (b) analyzing content of the digital image of the document to detect pre-defined content; (c) issuing an alarm if the pre-defined content is detected; and (d) printing the digital image of the document if the pre-defined content is not detected.

It is to be understood that both the foregoing general description and the following detailed description are exemplary and explanatory and are intended to provide further explanation of the invention as claimed.

### BRIEF DESCRIPTION OF THE DRAWINGS

FIGS. 1A and 1B illustrate a content-based accounting method for a copier, scanner, printer or MFP according to an embodiment of the present invention.

FIG. 2 schematically illustrates a data processing system including a copier, scanner, printer or MFP in which the content-based accounting method according to embodiments of the present invention may be implemented.

### DETAILED DESCRIPTION OF PREFERRED EMBODIMENTS

Embodiments of the present invention provide a content-based accounting method implemented in a management section for a copier, scanner, printer or multifunction device (often referred to as MFP or AIO (all-in-one), which is a device that combines copy, scan and print functions), or on a networked server accessible by the copier, scanner, printer or MFP. According to this method, the management section automatically extracts information from the content of the documents being copied, scanned or printed, and uses that information to perform accounting functions and/or other management functions. For ease of reference, in this disclosure, the term “image reproduction device” is used to refer to a copier, a scanner, a printer, a multifunction device, or any other device that includes a copy, scan or print function or a combination of such functions.

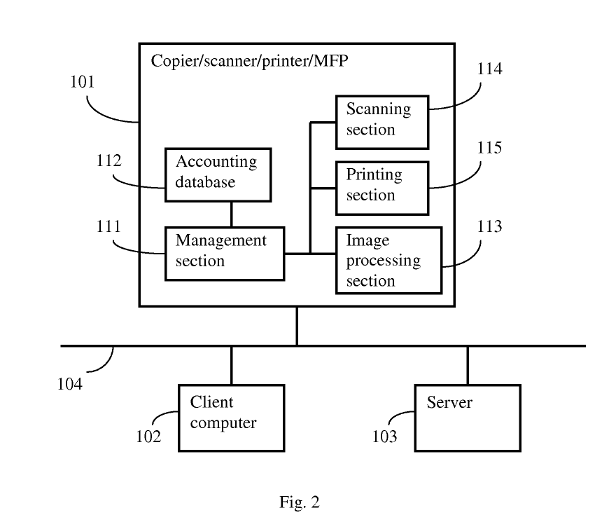

FIG. 2 schematically illustrates a data processing system including an image reproduction device 101 in which the content-based accounting method according to embodiments of the present invention is implemented. The image reproduction device 101 is optionally connected to one or more client computers 102 and/or one or more servers 103 by a network 104. It may alternatively be connected to a client computer or server by a direct connection such as a cable (not shown). The image reproduction device 101 includes a management section 111, implemented by hardware, software or firmware, that performs a content-based accounting method. The management section 111 maintains and updates an accounting database 112 stored in the device 101. The image reproduction device 101 also includes a scanning section 114 for generating digital image data by scanning a physical medium (e.g. paper) and/or a printing section 115 for forming an image on a physical medium from digital image data. A scanner only device will not include a printing section; a printer only device will not include a scanning section; while a copier device or a MFP will include both a scanning section and a printing section. The image reproduction device 101 also includes an image processing section 113, and other necessary or desired components (not shown in FIG. 2) such as memories, I/O section, control sections, additional data processing sections, etc. The scanning section 114, printing section 115, memory, I/O, control sections and data processing sections are components commonly found in conventional copiers, scanners, printers and MFPs.

Although the management section 111 and the accounting database 112 are shown in FIG. 2 as residing on the image reproduction device 101, if the device is connected to a network, the management section 111 and the accounting database 112 may alternatively reside on a remote server 103 or a client computer 102 connected to the network. Using such a configuration, multiple image reproduction devices connected to the same network (which is often the case in large organizations) may be centrally managed and accounting information may be gathered and pooled by the management section 111 located on a server 103.

The accounting database 112 contains user accounts (including individual users, groups of users, projects, etc.) and stores usage device information for each account. For example, the database may store the number of pages copied, scanned or printed by each user. Further, as will be described below, the image reproduction device analyzes the content of the documents being copied, scanned or printed, and stores usage information in the accounting database based on a grouping of the contents. For example, for each user, the database may store the number of pages of photographs copied/scanned/printed, the number of documents copied/scanned/printed that relate to a particular project or a particular subject, etc. In the commonly owned, co-pending U.S. patent application Ser. No. 11/691656 filed Mar. 27, 2007, a method is described where a copier automatically stores images of previously copied documents, groups or indexes the images, and recall them for reprinting later. In embodiments of the present invention, the copied, scanned or printed documents are not required to be indexed or stored on the image reproduction device (although they may be); rather, information about their content is extracted and used to update the accounting database 112.

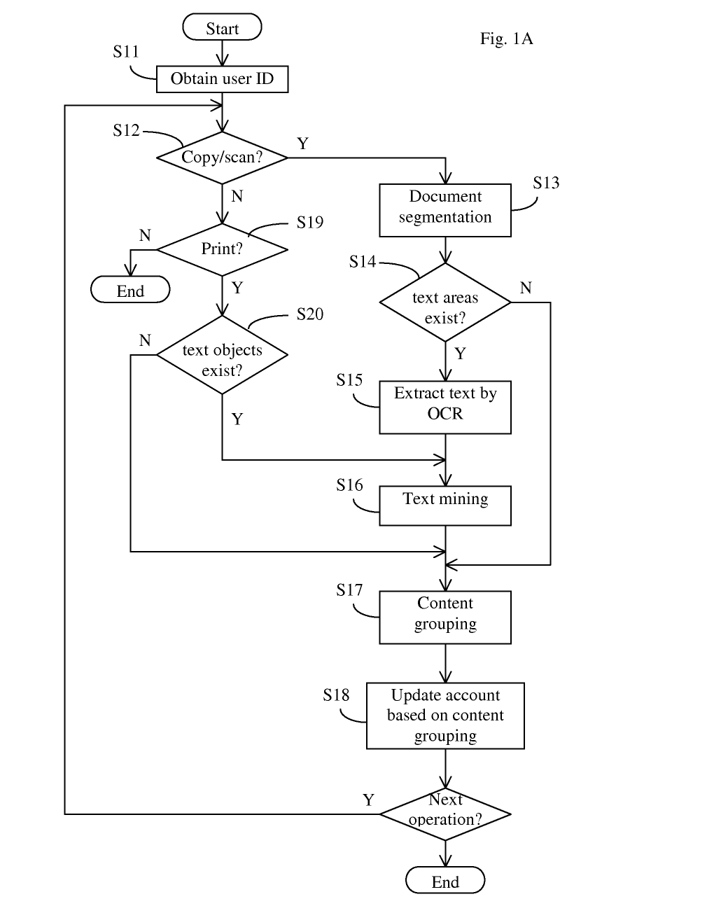

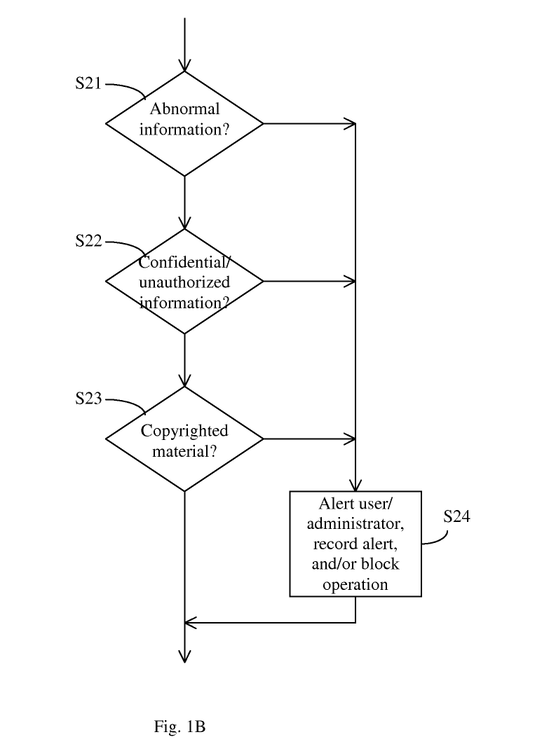

FIG. 1A illustrates a content-based accounting method according to an embodiment of the present invention. A MFP device is used as an example, but the method can also be implemented on a copier only, scanner only or printer only device. As shown in FIG. 1A, each time a copy, scan or print operation is initiated, the management section 111 obtains the user ID of the user performing the operation (step S11). For a copy or scan operation, the user ID is typically obtains from a logon procedure performed by the user at the image reproduction device using a user interface of the image reproduction device or an attached input device. For a print operation, the action is typically initiated from a client computer, and the user ID may be obtained from the client computer. If the operation to be performed is copy (i.e. generating physical copies of a physical document) or a scan (i.e. generating a digital file from the physical document but does not generate a physical copy) (“Y” in step S12), the image reproduction device performs the copy or scan operation (steps not shown in FIG. 1A), which results in a digital image of the document generated from the physical document being copied or scanned. A digital image is generated in a copy operation because copying is accomplished by first scanning the physical document to generate digital image data, and then printing a physical copy of the document from the digital image data. The management section segments the digital image obtained in the copy or scan action (step S13). In this step, the document image is first segmented into text and non-text regions. Then, the text regions are further segmented into pure text portions, mathematical formulas, tables, and so on in order to feed the text into OCR. The non-text region may be further segmented into images, graphs, etc. Next, if necessary, layout analysis, logical analysis and semantic analysis can be done for the non-text regions. As a result of the document segmentation step, if it is determined that one or more text areas exist in the document image (“Y” in step S14), an OCR (optical character recognition) procedure is performed to extract textual information from the digital image (step S15). Techniques for distinguishing text from non-text in a digital image and extracting textual information from a digital image are well known in the art.

After extracting the textual information, the management section performs text mining (step S16) to obtain information regarding the content of the document. Text mining generally refers to discovery of previously unknown information by automatically analyzing the input text and extracting information from the text. It broadly includes concept extraction, document summarization and other relevant tasks. Step S16 may be implemented using existing text mining techniques; users and organizations may also implement techniques tailored to their specific needs, including searching for predefined text strings for predefined content category or searching for other specific information. The information obtained in the text mining step S16 may include title, subject, author, timestamp, routing information, reference codes, type of the document, the organization or project to which the document belongs, keywords, content category of documents, and other information related to the content of the document. The techniques of document layout analysis, logical analysis, etc. can be used together with text mining to obtain the content information.

The information obtained in the text mining step S16 is used to perform content grouping of the document (step S17), i.e., classifying the document based on its content and assigning it to a content group. Content groups may be predefined by the user or organization to suit their needs. For example, documents related to a particular project may be defined as a content group, legal documents may be defined as another content group, etc. Note that grouping the document does not require storing the document image itself. The management section then updates the account of the user (or of the user group, project, etc.) stored in the accounting database, using the content grouping information of the document as well as other relevant information (step S18). The other relevant information may include the number of pages of the document, paper size/paper weight/paper type of the paper used to copy the document, etc., and may be obtained from the image reproduction device. Thus, for example, the management section may record that the user has copied a presentation for project A using 20 sheets of a particular type of paper.

If in step S14 it is determined that no text area exists in the document image (“N” in step S14), then steps S15 and S16 are omitted. The management section performs content grouping based on the non-textual content of the document, which may be categorized into graphics, photographs (which may be further categorized into portrait images, scenery images, etc.), etc. The management section then updates the account in the accounting database using the content grouping information (step S18). For example, the management section may record that the user has copied a portrait photograph.

If rather than copy or scan, a print operation (i.e. producing a physical copy of a document from digital data) has been initiated (“N” in step S12 and “Y” in step S19), the image reproduction device receives a digital document and prints it (steps not shown in FIG. 1A). The management section examines the digital document to determine whether one or more text objects exist in the document (step S20). If they do (“Y” in step S20), the management section performs text mining (step S16), content grouping (step S17) and account update (step S18) as described earlier in connection with copy/scan. If no text objects exist in the document being printed (“N” in step S20), then steps S16 is omitted, and the management section performs content grouping based on the non-textual objects of the document (step S17) and updates the account (step S18). Although not shown in FIG. 1A, the digital document supplied to the print section in a print operation may be a digital image that contains textual content. In this case the digital document (digital image) may be processed in the same way as a digital image generated by the scanning section in a copy or scan operation, including an OCR step if appropriate.

Steps S12 to S20 may be repeated if the user desires additional copy, scan or print operations.

An optional critical checking process may be performed based on the textual information obtained in the text mining step (step S16). The process is shown in FIG. 1B, and may be performed at any time after step S16 in FIG. 1A. The critical checking process may check the content of the textual information using various criteria, such as abnormal content (e.g. violence, pornography, racial hatred, etc. (step S21), unauthorized or confidential information (step S22), copyrighted materials (step S23), etc. The criteria may be defined by a user or an administrator of the image reproduction device. The image reproduction device may be programmed so that if any such information is detected in the document being copied, scanned or printed, the image reproduction device issues an alert to the user or an administrator, records an alert to be reviewed later by the user or someone else, or block the copy, scan or print operation (step S24). The digital image of the copied, scanned or printed document may be optionally retained in the device as a record.

The content-based accounting method according to embodiments of the present invention may be useful in various settings in which an image reproduction device is used. When the image reproduction device is used in a large organization where multiple such devices are connected via a network, content-based accounting may be useful for accounting and other management purposes within the organization. When the image reproduction device is used in a retail environment, information may be obtained by analyzing the content extracted from documents copied, scanned or printed by retail users for marketing purposes.

As mentioned earlier, the management section 111 may be located on a server 103 remote from the image reproduction device 101. The various functions of the management section may be implemented in separate modules, such as an OCR module, a text mining module, a database module for updating the accounting database, etc. Alternatively, the various steps shown in FIGS. 1A and 1B may be performed in a distributed manner using processing capabilities of the image reproduction device 101 and the server 103/client 102. For example, the OCR step (step S15) may be performed by the image reproduction device and the text mining (step S16) and subsequent steps may be performed by the server, so that only text data needs to be transferred from the image reproduction device to the server.

It will be apparent to those skilled in the art that various modification and variations can be made in the content-based accounting method of the present invention without departing from the spirit or scope of the invention. Thus, it is intended that the present invention cover modifications and variations that come within the scope of the appended claims and their equivalents.

What is claimed is:

1. A method for managing an image reproduction device for copying or scanning a document, comprising:
(a) copying or scanning the document using the image reproduction device, including obtaining a digital image of the document;
(b) analyzing content of the digital image of the document;
(c) grouping the document based on the analysis of the content; and
(d) updating an accounting database based on the grouping of the document, the accounting database containing user accounts and storing usage information for each user account according to content groups.

2. The method of claim 1, wherein step (b) includes:
(b1) segmenting the digital image into areas;
(b2) determining whether one or more text areas exist in the digital image; and
(b3) extracting textual information from the text areas if they exist and analyzing the extracted textual information.

3. The method of claim 2, where step (b) further includes analyzing non-textual content of the digital image.

4. A method for managing an image reproduction device for printing a document from digital data, comprising:
(a) printing the document from the digital data using the image reproduction device;
(b) analyzing content of the digital data;
(c) grouping the document based on the analysis of the content; and
(d) updating an accounting database based on the grouping of the document, the accounting database containing user accounts and storing usage information for each user account according to content groups.

5. The method of claim 4, wherein step (b) includes:
(b1) determining whether one or more text objects exist in the digital data; and
(b2) analyzing textual information in the text objects.

6. The method of claim 4, where step (b) further includes analyzing non-textual objects of the digital data.

7. An image reproduction device comprising:
a scanning section for generating digital images representing a document by scanning a physical medium;
an accounting database containing user accounts and storing usage information for each user account according to document content groups; and
a management section for analyzing content of digital images generated by the scanning section, grouping the document represented by the digital image or digital data based on the analysis of the content, and updating the accounting database based on the grouping of the document.

8. The image reproduction device of claim 7, wherein the management section includes an optical character recognition module for extracting textual information from the digital images.

9. The image reproduction device of claim 7, further comprising a printing section for forming images on a physical medium from digital images generated by the scanning section.

10. An image reproduction device comprising:
a printing section for forming images on a physical medium from digital data representing a document supplied to the printing section;
an accounting database containing user accounts and storing usage information for each user account according to document content groups; and
a management section for analyzing digital data supplied to the printing section, grouping the document represented by the digital data based on the analysis of the content, and updating the accounting database based on the grouping of the document.

11. The image reproduction device of claim 10, wherein the management section includes an optical character recognition module for extracting textual information from the digital data.

12. A method for managing an image reproduction device for copying or scanning a document, comprising:
(a) scanning the document using the image reproduction device to obtain a digital image of the document;
(b) analyzing content of the digital image of the document to detect pre-defined content;
(c) issuing an alarm if the pre-defined content is detected; and
(d) printing the digital image of the document if the pre-defined content is not detected.

13. The method of claim 12, wherein step (b) includes:
(b1) segmenting the digital image into areas;
(b2) determining whether one or more text areas exist in the digital image; and
(b3) extracting textual information from the text areas if they exist and analyzing the extracted textual information to detect the pre-defined content.
